(19) United States
(12) Patent Application Publication
(10) Pub. No.: US 2023/0250037 A1
(43) Pub. Date: Aug. 10, 2023

(54) GRANULES OF POLYHALITE AND UREA AND A COMPACTION PROCESS FOR THE PRODUCTION THEREOF

(71) Applicant: ICL EUROPE COOPERATIEF U.A., Amsterdam (NL)

(72) Inventors: Khalil ABU-RABEAH, Beer Sheva (IL); Ruben SOCOLOVSKY, Beer Sheva (IL); Marina DAKOV, Arad (IL); Yacov LEVY, Dimona (IL); Natalia GEINIK, Arad (IL); Moshe GOLDFARB, Beer Sheva (IL)

(21) Appl. No.: 17/785,999

(22) PCT Filed: Dec. 28, 2020
(86) PCT No.: PCT/IL2020/051335

§ 371 Date: Jun. 16, 2022

Related U.S. Application Data
(60) Provisional application No. 62/966,093, filed on Jan. 27, 2020.

(51) Int. Cl. C05G 5/12; C05C 9/00

(52) U.S. Cl. CPC C05G 5/12; C05C 9/005

(57) ABSTRACT

There is provided herein a granule comprising polyhalite in a concentration of between 20-80% w/w and urea in a concentration of between 20-50% w/w and optionally a binder, wherein said granule comprises a granule strength of at least 1.1 Kg/ granule.

### FIELD OF THE INVENTION

The present invention relates to the field of composite fertilizers, specifically to production of a compacted polyhalite and urea fertilizer.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:
Nitrogen (N): leaf growth;
Phosphorus (P): Development of roots, flowers, seeds, fruit;
Potassium (K): Strong stem growth, movement of water in plants, promotion of flowering and fruiting;
three secondary macronutrients: calcium (Ca), magnesium (Mg), and Sulphur (S); micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts. The most reliable and effective way to make the availability of nutrients coincide with plant requirements is by controlling their release into the soil solution, using slow release or controlled release fertilizers.

Both slow release fertilizers (SRF) and controlled release fertilizers (CRF) supply nutrients gradually. Yet, slow release fertilizers and controlled release fertilizers differ in many ways: The technology they use, the release mechanism, longevity, release controlling factors and more.

Solid fertilizers include granules, prills, crystals and powders. A prilled fertilizer is a type of granular fertilizer that is nearly spherical made by solidifying free-falling droplets in air or a fluid medium. Most controlled-release fertilizers (CRFs) used in commercial nurseries are prilled fertilizers that have been coated with sulfur or a polymer. These products have been developed to allow a slow release of nutrients into the root zone throughout crop development.

Polyhalite is an evaporite mineral, a hydrated sulfate of potassium, calcium and magnesium with formula: K₂Ca2Mg(SO₄)₄ 2H₂O. Polyhalite is used as a fertilizer since it contains four important nutrients and is low in chloride:
48% SO₃ as sulfate
14% K₂O
6% MgO
17% CaO

Nitrogen is essential component for the plant. N containing fertilizers like Urea, ammonium nitrate, ammonium sulphate calcium nitrate and Magnesium nitrate are useful for the plant’s growth.

Urea, also known as carbamide, is an organic compound with chemical formula CO(NH₂)₂. This amide has two —NH₂ groups joined by a carbonyl (C=O) functional group.

Polyhalite and urea, although both useful for the proper growth of a plant are practically un-mixable due to urea is considered a ductile material, and polyhalite is a mined non-ductile substance. From a chemical point of view it is extremely difficult of cause the adherence of these two substances without using shear force as these are both solids.

### SUMMARY OF THE INVENTION

According to some demonstrative embodiments, there is provided herein a granule of polyhalite and urea.

According to some embodiments, the concentration of polyhalite in the granule may be in a range between 20-80% w/w, preferably, between 30-70% w/w, most preferably between 40-60% w/w.

According to some embodiments, there is provided a process for the compaction of Polyhalite with a urea, the process comprising:
mixing a feed of polyhalite with a feed of urea and optionally a binder in a mixer to yield a mixture;
compacting in a compactor to yield masses;
crushing said masses in a crusher to yield particles; and
screening said particles in a screener to yield different particles in three different sizes: oversized particles which undergo a second crushing process and are retuned to said screener for screening, undersized particles which are transferred to said mixer for further mixing, and desired size granular particles which are transferred to a polish screener.

### DETAILED DESCRIPTION OF THE INVENTION

According to some demonstrative embodiments, there is provided herein a granule of polyhalite and urea.

According to some embodiments, plants need nitrogen to grow, develop and produce usable products. Since plants get their nitrogen from the soil, farmers must replenish nitrogen to ensure successful growth and to replace nitrogen removed in the harvested crop.

When plants are not provided with sufficient nitrogen, they become nitrogen deficient. Plants with nitrogen deficiency often have spindly stems and their growth is stunted.

Nitrogen use efficiency (NUE) is the fraction of applied nitrogen that is absorbed and used by the plant. Improving a plant’s ability to utilize nitrogen is a key component in enhancing environmental sustainability. Due to the substantial yield increases resulting from fertilization, farmers have steadily increased the amount of fertilizer added per unit of land area. According to some embodiments, the unique combination of polyhalite and urea in a single compacted granule allows for the NUE to be increased, e.g., without increasing the amount of fertilizer provided to the plants.

According to some embodiments, the concentration of polyhalite in the granule may be in a range between 20-80% w/w, preferably, between 30-70% w/w, most preferably between 40-60% w/w.

According to some embodiments, there is provided a process for the compaction of Polyhalite with a urea, the process comprising:
mixing a feed of polyhalite with a feed of urea and optionally a binder in a mixer to yield a mixture;
compacting in a compactor to yield masses;
crushing said masses in a crusher to yield particles; and
screening said particles in a screener to yield different particles in three different sizes: oversized particles which undergo a second crushing process and are retuned to said screener for screening, undersized particles which are transferred to said mixer for further mixing, and desired size granular particles which are transferred to a polish screener.

The final product contain: N,K,S,MgO,CaO

The mixture for the compactor may contain 50-70% w/w of Polyhalite, 20-50% w/w of Urea and optionally a binder.

According to some embodiments, the mixing may be performed in a blade blender and/or any other suitable devise capable of having a rotation speed that creates a swirling motion for a perfect homogenization and a high blending precision, e.g., a Ploughshare ® Mixer.

According to some demonstrative embodiments, the compaction may be a wet compaction.

The compaction process may include the addition of a binder 1-5% binder. The binder may include but not limited : for example, organic or inorganic binders, such as, starch, bentonite, sodium silicate, lignosulfonates, molasses, hydrated lime, bitumen, Portland cement, clay, acids, cellulose gum, sucrose, water, water glass, cements, Fly Ash, Potassium and Sodium

Silicate, MgO, CaO, Alganite, Geo-polymers, oils and waxesand the like, or a combination thereof.

The dry compaction process may include the following steps:

Mixing Potash with Ammonium Sulphate according to the formula. Adding micronutrients.

Adding organic or inorganic binder between 1-5% preferably between 2-4%1-2%

Adding water between 0.5-2%, preferably 0.5-1%.

The mixture may be heated to a temperature between 80-180° C., preferably 160° C.
Feeding the mixture into a compactor to provide compacted flakes;
Grinding of the flakes;
Sieving of the grinded flakes; and
After sieving there are three types of yield:
   1. Desired sized flakes - between 14 - 33 mm thickness, S.G. between 1.9 to 2.4 g/cm³. According to some embodiments, the desired size of the flakes (also referred to herein as “particles” or “granules”) is between 1-6 mm, most preferably between 2-4 mm.
   2. Oversized (OS) flakes - are returned to the grinding stage, e.g., between 4-20% w/w of the total resulting flakes.
   3. Undersized (US) flakes - are recycled to the mixture for compaction, e.g., between 10 to 80% w/w of the total resulting flakes.

According to some embodiments, in the dry process, optionally a binder may be added in a concentration of between 0.01-7% w/w, preferably between 1-5% w/w, most preferably between 2-4% w/w.

The final product may submitted to post-treatment oil may be added to the resulting granules, e.g., to improve the rheology of the product and diminish dust formation. Polishing the granules or Coating. The resulting flakes/granules may be glazed and further coated with a suitable coating.

For example, the coatings may include biodegradable coatings, sustained release coatings, controlled release coatings, oily coatings, wax coatings. The dry compaction process may include the following steps:
1. Mixing materials -3 Kg of mixture containing Poly halite, urea and binder in 200 lit mixer
2. Adding binder
3. Adding water
4. Compacting- Diameter 600 mm, width 145 mm, working force 100 KN/cm. roll velocity 6 rpm.
5. Crushing using hammer mill-
6. Screening
7. Drying the granule between 2-4 mm Single strength 1.3 Kg/granules
8. Recycling-80%
9. Analysis. All analyses conducted according to the standard procedure

### Example 1

50% polyhalite + 50% urea
Abrasion in - 12 mesh 22%
Eco dust 1.9%
Strength of granule immediately after production 1.4 Kg granule
Strength of granule after 1 month 2.3 Kg granule

### Example2

70% polyhalite + 30% urea
Abrasion in - 12 mesh 26%
Eco dust 2.2%
Strength of granule immediately after production 1.4 Kg granule
Strength of granule after 1 month 2.2 Kg granule

### Example 3

70% polyhalite + 20% urea+10%ammonium sulphate
Abrasion in - 12 mesh 40%
Eco dust 2.3%
Strength of granule immediately after production 1.1 Kg granule
Strength of granule after 1 month 1.3 Kg granule

### Example 4

70% polyhalite + 22% urea+6%ammonium sulphate+2% ligno sulphonate
Abrasion in - 12 mesh 16%
Eco dust 0.9%
Strength of granule immediately after production 1.2 Kg granule
Strength of granule after 1 month 1.9 Kg granule

### Example 5

48% polyhalite + 50% urea+2%starch
Abrasion in - 12 mesh 28%
Eco dust 1.8%
Strength of granule immediately after production 1.1 Kg granule
Strength of granule after 1 month 1.9 Kg granule

### Example 6

48% polyhalite + 50% urea+2% lignosulphonate
Abrasion in - 12 mesh 12%
Eco dust 0.8%
Strength of granule immediately after production 2 Kg granule
Strength of granule after 1 month 3.3 Kg granule.

1. A granule comprising polyhalite in a concentration of between 20-80% w/w and urea in a concentration of between 20-50% w/w and optionally a binder, wherein said granule comprises a granule strength of at least 1.1 Kg/granule.

2. The granule of claim 1, wherein said binder is present in an concentration of between 1-5% w/w.

3. The granule of claim 2, wherein said concentration is between 1-2% w/w.

4. The granule of claim 2, wherein said binder is a lignosulphonate.

5. The granule of claim 2, wherein said binder is starch.

6. A process for the compaction of Polyhalite with a urea, the process comprising:
mixing a feed of polyhalite with a feed of urea and optionally a binder in a mixer to yield a mixture;
compacting in a compactor to yield masses;
crushing said masses in a crusher to yield particles; and
screening said particles in a screener to yield different particles in three different sizes: oversized particles which undergo a second crushing process and are retuned to said screener for screening, undersized particles which are transferred to said mixer for further mixing, and desired size granular particles which are transferred to a polish screener.

7. The process of claim 6, wherein said polyhalite is in a concentration of between 20-80% w/w and urea is in a concentration of between 20-50% w/w.
